(19) United States
(12) Patent Application Publication
(10) Pub. No.: US 2006/0216977 A1
(43) Pub. Date: Sep. 28, 2006

(54) Portable equipment

(76) Inventor: Hideo Kato, Kanagawa (JP)

Correspondence Address: NOTARO AND MICHALOS, 100 DUTCH HILL ROAD, SUITE 110, ORANGEBURG, NY, 10962-2100, US

(21) Appl. No.: 11/385,436

(22) Filed: Mar. 21, 2006

(30) Foreign Application Priority Data
Mar. 25, 2005 (JP) 2005-088863

(51) Int. Cl. H01R 13/62

(52) U.S. Cl. 439/157; 16/325

(57) ABSTRACT

To provide a portable equipment allowing, not only for a normal opening-closing operation in a vertical direction, and also for a slide operation from a fully opened position, the above-indicated portable equipment includes opening-closing mechanisms incorporating both a function for a normal opening-closing and that for a slide operation; via these opening-closing mechanisms, the above-indicated portable equipment enables a closed, half-opened, and fully-opened positions of the above-indicated case bodies, and further a slide position, in which both the case bodies are superimposed on each other.

### BACKGROUND OF THE INVENTION

1. Field of the Invention

The present invention relates to a portable equipment, suitable for a use in opening and closing a first case body and a second case body, which are constituent parts of a portable telephone, etc.

2. Description of the Related Art

Among portable telephones which belong to portable equipment, foldable ones are marketed; these foldable portable telephones have a first case body which includes on a top surface thereof a keyboard portion and a microphone portion, etc. on one hand, and a second case body which is equipped on a top surface thereof with a display portion and a speaker portion, etc. on the other; further in the above-mentioned foldable portable telephones, the second case body is rotatably connected via a hinge device with the rear portion of the top surface of the first case body. This configuration allows the above two case bodies to be superimposed on each other to be closely contacted, further realizing a closure of a transmitter portion, while due to the same configuration one of the case bodies is to be released from a superposition (a closed condition) thereof on the other to expose the transmitter portion. There are marketed portable telephones provided with a slide mechanism, which allow the second case body to be completely superimposed on the first case body and to thus cover the top surface thereof; further in these marketed portable telephones, a slide operation of the second case body with regard to the first case body via slide mechanisms in a longitudinal direction, enables the top surface of the first case body to be exposed. A known art thereof is a Japanese Laid-Open 2004-235897.

In the meantime conventional telephones either open or close a first and a second case body either by a relative rotation in a longitudinal direction, or by a slide operation, but none enables both the so-called normal opening and closing operation through a relative vertical operation and opening and closing operation through a relative slide operation. Nonetheless in the recent years, portable telephones found in the market include various functions as those using communication lines as internet, and not limited to a call. Given these various functions, e.g. if user desires to look an animation displayed on a display portion as an LCD, he will have no need to leave open his portable telephone, as opened by a vertical rotation; therefore; if he can relatively slide the display portion remaining exposed to the outside, toward a position at which it is superimposed on a keyboard portion.

### SUMMARY OF THE INVENTION

For solving the above-mentioned problems, it is an object of the present invention to provide a portable equipment which enables a normal opening and closing operation, as well as a slide operation of either one of the case bodies fully opened with a display portion being exposed, for another closed condition.

In order to attain the above-described object, the present invention is a portable equipment for allowing, via an opening and closing mechanism, for a closed condition, in which a top surface of either one of a first case body and a second case body is covered by either other one, and for an opened condition, in which either one of said first case body and said second case body is exposed. The present invention is characterized in that the above-indicated opening-closing mechanism is composed of an engagement convex portion attached to either one of the above-indicated first case body and the above-indicated second case body, a rotation concave portion which, located on either other one of the above-indicated first case body and the above-indicated second case body, rotatably supports each of the above-indicated first case body and the above-indicated second case body; a slide concave portion which is joined with the above-indicated rotation concave portions, and slidably supports the above-indicated first case body and the above-indicated second case body by an engagement with the above-indicated engagement convex portion, a rotation cam mechanism which restricts a rotation of the above-indicated first case body and the above-indicated second case body, a slide control mechanism which allows the above-indicated first case body and the above-indicated second case body to be slid, while both case bodies are fully opened. Further the present invention is characterized in that the above-indicated portable equipment allows, via the above-indicated opening-closing mechanism, the above-indicated second case body to be opened and closed with regard to the above-indicated first case body, with a supporting point at one end portion thereof, thus enabling the above-indicated second case body to be fixed at closed, half opened and fully opened position. Moreover the present invention is characterized in that the above-indicated first case body and the above-indicated second case body are each slid from the fully opened position to be superimposed on each other at a slide position.

In the present invention, a first case body and a second case body can produce a closed position, a half-opened position and a fully opened position, and further a slide position in which the second case body is superimposed on the first case body via a slide operation in a linear direction from the fully opened position. Hence two kinds of opening/closing operations, a normal opening/closing operation and the one via slide operation, are both available, thus improving operability.

Further the present invention is preferably characterized in that the above-indicated engagement convex portion has a shaft and a cam provided on an outer circumference around an axis thereof. Additionally the present invention is also preferably characterized in that the above-indicated slide control mechanisms is composed of the above-indicated cam including a through hole penetrating each of the above-indicated shafts in eccentricity, the above-indicated slide concave portion joined in eccentricity with the above-indicated rotation concave portion.

Furthermore, the present invention is preferably characterized in that a ball unit is mounted on a fore end portion of the above-indicated shaft with a slide convex portion, and the above-indicated ball unit can appear from the fore end portion and is biased in a direction in which a slide convex portion protrudes, and that the above-indicated slide concave portion provided with a slide groove portion allows slides a slide convex portion.

Moreover, the present invention is preferably characterized in that the above-indicated ball unit is composed of a case member attached to the above-indicated shaft and having an appearance hole, a ball bearing installed in the above-indicated case member so as to appear from the above-indicated appearance hole, and a biasing member for biasing the above-indicated ball bearing in a direction in which the above-indicated ball bearing protrudes.

Additionally, the present invention is preferably characterized in that the above-indicated engagement portion has a shaft, and that the above-indicated rotation cam mechanism are each composed of a first cam formed on an outer circumference of a fore end portion of each of the above-indicated shafts to be rotatable around the above-indicated shafts, a second cam to be shifted in an axial direction of the above-indicated shafts and contacted on surface with the above-indicated first cam, a biasing means for biasing the second cam toward the above-indicated first cam, cam convex portions mounted on either one of contact surfaces of the above-indicated first cam and of the above-indicated second cam, cam convex portions formed on a contact surface of the above-indicated first cam and/or a contact surface of the above-indicated second cam for being engaged with the cam convex portions and locking the above-indicated first case body and the above-indicated second case body at a predetermined position, and a cam rotation portion mounted on rotation convex portions for rotating only the above-indicated first cam with regard to the above-indicated shaft, in parallel to a relative rotation of the above-indicated first case body and the above-indicated second case body.

The present invention is also preferably characterized in that a hinge case is fixed to either one of the above-indicated first case body and the above-indicated second case body, that the above-indicated shaft is mounted on the hinge case, that a second cam is mounted for restraining a rotation of the above-indicated shaft via an engagement with the above-indicated hinge cases, that a first cam is mounted on an outer periphery of a fore end portion of the above-indicated shaft, and that a biasing means is mounted between the above-indicated second cams and the above-indicated hinge case, and an opening-closing unit is constituted.

In addition, the present invention is preferably characterized in that either one of the above-indicated first case body and the above-indicated second case body is formed in a shape of U, with upright portions on both side portions, that the above-indicated opening-closing unit is fixed on a portion on an inner surface close to an end portion, on the side portion, that slide concave portion is mounted at least on one of side portions of either other one of the above-indicated first case body and the above-indicated second case body, and that the above-indicated rotation concave portion is mounted on one end portion of the slide concave portions.

In the present invention as above described, a first case body and a second case body can produce a closed position, a half-opened position and a fully opened position, and further a slide position, in which the second case body is superimposed on the first case body via a slide operation in a linear direction from the fully opened position. Hence two kinds of opening/closing operations, a normal opening/closing operation and the one via a slide operation, are both available, thus improving operability.

### BRIEF DESCRIPTION OF THE DRAWINGS

FIGS. 1A to 1C are side views showing a portable telephone as an example of a portable equipment of the present invention, namely FIG. 1A presenting a closed condition of the portable telephone using the rotation cam mechanism, FIG. 1B an opened condition using the rotation cam mechanism, and FIG. 1C the closed condition using the slide mechanism;

FIG. 2 is a plan view showing a portable telephone as an example of a portable equipment of the present invention, which is opened;

FIG. 3 is a cross sectional schematic view, showing one of slide mechanisms of the present invention;

FIG. 4 is a perspective schematic view, showing an attached condition of an opening-closing unit of the present invention;

FIGS. 5A to 5D are views showing one of opening-closing units of the present invention, 5A being a perspective view, 5B being a side view, 5C being a front view, 5D being an exploded cross sectional plane view;

FIG. 6 is a perspective schematic view, showing a rotation concave portion and a slide concave portion of the present invention;

FIGS. 7A and 7B are views showing an important portion of rotation concave portion according to the present invention, FIG. 7A being a perspective view, FIG. 7B being a front view.

### DETAILED DESCRIPTION OF THE PREFERRED EMBODIMENT(S)

Hereinafter, a portable equipment according to the present invention will be described in detail, based on the accompanying drawings.

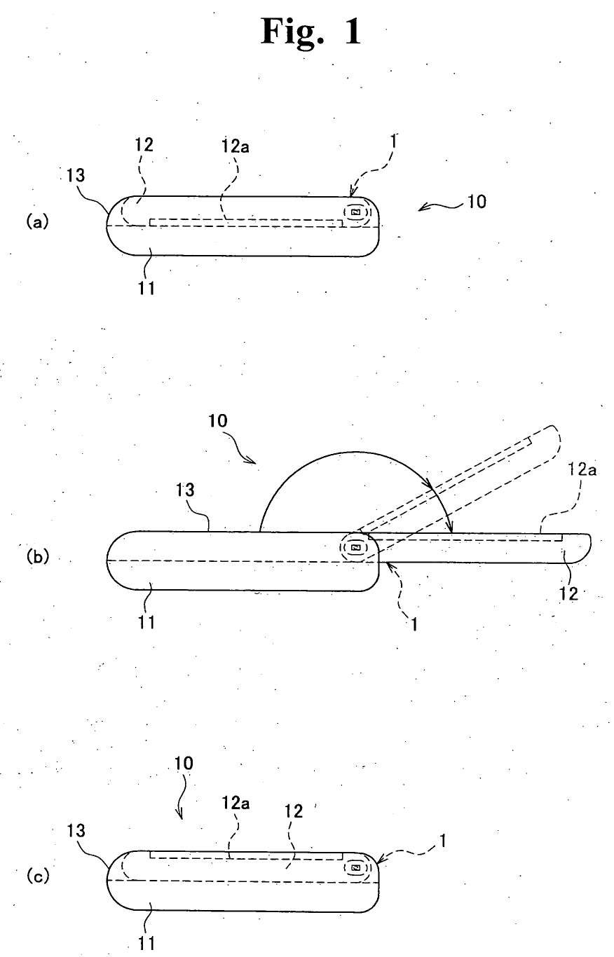

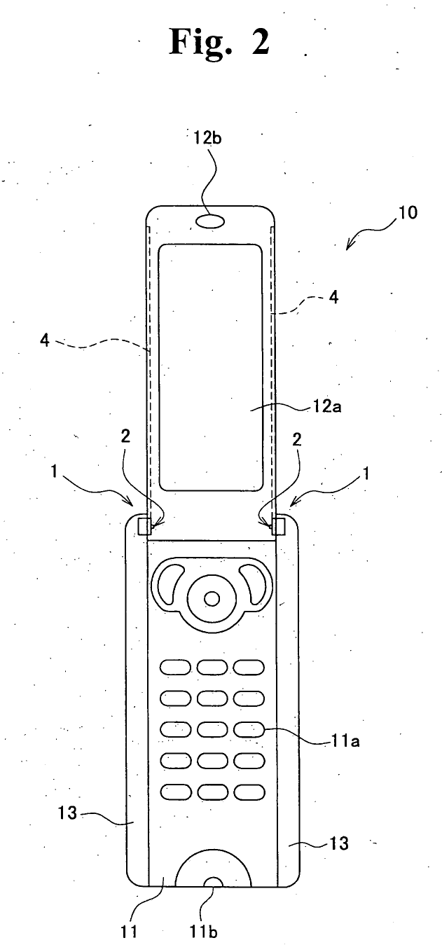

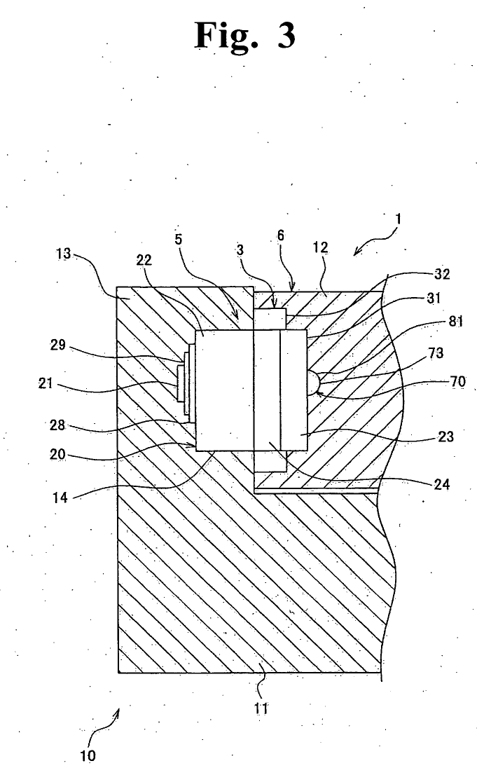

FIGS. 1 and 2 show an embodiment of a portable telephone as a portable equipment according to the present invention; FIG. 3 presents an embodiment of an opening-closing mechanism according to the present invention. As shown in FIGS. 1 to 3, the portable equipment according to the present invention is composed of a first case body 11 and a second case body 12, and enables, with a use of the opening-closing mechanisms, either one of the above indicated case bodies, e.g. the second case body 12 to be in a closed condition, covering a top surface of either other one, e.g. the first case body 11 (see FIGS. 1A and 1C); furthermore, the above-indicated portable equipment allows a top surface of the first case body 11 to be exposed (see FIGS. 1B and 2).

A portable equipment is not particularly limited, but implies e.g. portable telephones, portable information terminals such as Zaurus™, electric calculators, pocket computers and portable video game machines; portable telephones are most favorable among the above as the portable equipment according to the present invention. Furthermore, it includes also ashtrays, lids for casings, etc. Accordingly it is not particularly limited as long as it allows two case bodies to be slid with regard to each other. In the meanwhile, the embodiments in the following illustrate a portable telephone 10 as an example of portable equipment, however, the embodiment is not limited to a portable telephone only.

A first case body 11 as a transmitter portion of a portable telephone 10 includes a keyboard portion 11a and a microphone portion 11b, etc. on the top surface thereof. The first case body 11 has a shape substantially of the letter U, with portions protruding upwards on the both side portions 13, 13 from a top surface thereof, and also has a shape virtually of a rectangle, oblong in plan view. A second case body 12 as a receiver portion of the portable telephone 10 is equipped on one surface thereof with a display portion 12a as LCD and a speaker portion 12b. The second case body 12 has a shape substantially of a rectangle, with a substantially same length as the first case body 11 in the longitudinal direction, and with a length shorter, e.g. slightly shorter than a distance between both side portions 13, 13 in a cross direction. Further the second case body 12 is generally as thick as the height of one of the side portions 13, 13 of the first case body 11; accordingly the second case body 12 is fitted between the side portions 13 and 13 of the first case body 11 to be superimposed.

A portable telephone 10 is composed of a second case body 12 connected via a pair of opening-closing mechanisms 1, 1 with a first case body 11; such connection allows the second case body 12 to be rotated with regard to the first case body 11, from a superposition thereon, and to be relatively slid in a longitudinal linear direction. In other words, the above-indicated portable telephone 10 enables one surface of the second case body 12 to be superimposed on a top surface of the first case body 11 to conceal a key board portion 11a, etc. as well as exposing it by means of a sliding operation of the second case body 12 from the top surface of the first case body 11.

A portable telephone 10 is characterized by an opening and closing via pair of opening-closing mechanisms 1,1 of a first case body 11 and a second case body 12 with a supporting point at one end portion thereof, allowing the latter to be fixed at three positions, i.e. closed, half opened and fully opened; another characteristic of the portable telephone 10 is that the second case body, as structured in the above-described manner, can be slid in a linear direction from a fully opened position, for a superposition on the first case body 11. (As for these opening-closing mechanisms 1, 1, since their structure is the same, the one on the left as shown in FIG. 2 is hereinafter described in terms of structure, function and effect thereof). The opening-closing mechanism 1 according to the present invention is further characterized by constituent components as follows: engagement convex portion 2 on either one of the first case body 11 and the second case body 12, e.g. on the first case body 11; a rotation concave portion 3 which, located on either other one of the first case body 11 and the second case body 12, e.g. on the second case body 12, supports the first case body 11 and the second case body 12 to be both rotatable; slide concave portion 4 which is joined with the rotation concave portion 3, through an engagement with engagement convex portions 2, and slidably supports the first case body 11 and the second case body 12; a rotation cam mechanism 5 which restricts a rotation of the first case body 11 and the second case body 12; a slide control mechanism 6 which allows the first case body 11 and the second case body 12 to be slid, while both case bodies are fully opened.

An engagement convex portion 2, through an engagement with a rotation concave portion 3, supports a first case body 11 and a second case body 12 to be both rotatable as well as supporting both case bodies to be slid on each other, as engaged with slide concave portions 4. The engagement convex portions 2 are not particularly limited, but it is favorable for these portions to be composed of an opening-closing unit 20 each having a shaft 21.

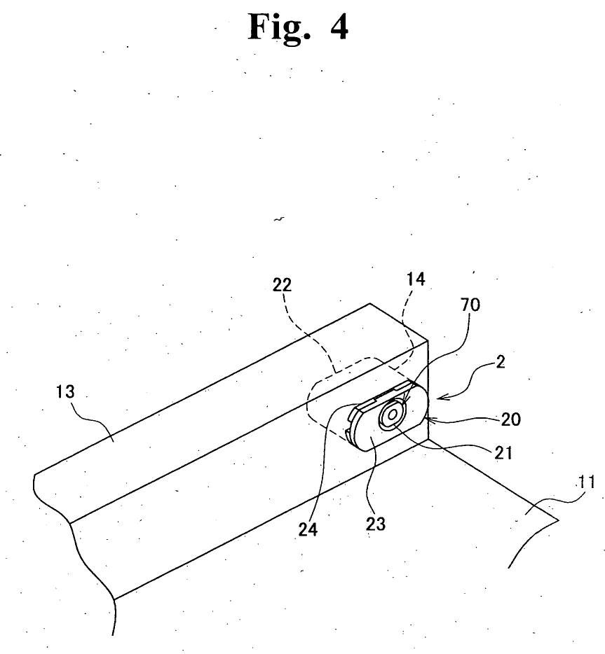

Opening-closing unit 20 is, as shown in FIGS. 3 to 5, fixed to a unit housing portion 14 close to a fore end portion (one opposed to the side with a microphone portion 11b) on an inner surface, and thus received by the above-indicated housing portion. It is desirable for the opening-closing unit 20 to be composed of a hinge case 22 fixed into and received by the unit housing portion 14, a shaft 21 attached to the hinge case 22, first cams 23 and second cams 24 each attached to the shaft 21, and biasing means 25 which each, attached to an interior surface of the hinge case 22, bear the second cam 24.

Hinge cases 22 are bottomed and have each on a cross section thereof a shape substantially of a rectangle, on which two of edges are curved toward both ends thereof; the hinge case 22 is thus fitted and received by a unit housing portion 14. It is favorable for both side portions of each of the hinge cases 22 to have curves. A penetrating hole 22a is cut on a bottom portion of the hinge case 22 for receiving herein the shaft 21 to penetrate through. It is desirable for the penetrating hole 22a to have a diameter larger, e.g. slightly larger than the shafts 21.

A shaft 21 is hollow, i.e. has a shape of a cylinder. A fore end portion of the shaft 21 is extended in diameter to be a flange portion 21a. An E-ring attaching portion 21b is provided on an outer circumference close to a rear end portion of the shaft 21. It is exposed from a bottom portion of a hinge case 22, after passing through a washer 28. A shaft 21 is fixed to the hinge case 22 via an E-ring 29 to be attached to the E-ring attaching portion 21b appearing on an outer surface of the hinge case 22. Furthermore, a ball unit housing portion 21c is provided on a fore end surface of the shaft 21 for receiving herein a ball unit 70.

A first cam 23, a second cam 24 and biasing means 25 are main constituent parts of rotation cam mechanisms 5 which constantly lock a second case body 12 with regard to a first case body 11 at a predetermined position. It is preferable for the rotation cam mechanisms 5 to lock the second case body 12 with regard to the first case body 11 e.g. at 0°, 150° and 180° within a range from 0° to 180° in which the second case body 12 is rotated. These angles are produced between longitudinal straight line of the first case body 11 and the one of the second case body 12 (the angles may be called rotation angles), and a connection of these case bodies via an opening-closing mechanism 1 is preferably realized so as to superimpose one on the other at 0° in such an angle and to close the case bodies. In the meantime, a reference to 0° in the present invention implies also degrees about 0°. Further, a reference to 150° in the present invention implies also degrees about 150°. Furthermore, a reference to 180° in the present invention implies also degrees about 180°.

A rotation cam mechanism 5 includes a first cam 23 mounted at a fore end portion of a shaft 21, on an outer circumference thereof, so as to be rotated around an axis and shifted in an axial direction, and a rotation mechanism 5 is composed of: a second cam 24 to be shifted in an axial direction of the shaft 21 and contacted on the surface with the first cam 23; a biasing means 25 for biasing the second cam 24 toward the first cam 23; a cam convex portion 26 mounted on either one of contact surfaces of the first cam 23 and the second cam 24, e.g. on a contact surface of the first cam 23; a cam concave portion 27 mounted on either other one of contact surfaces of the first cam 23 and the second cam 24, e.g. on a contact surface of the second cam 24, thus engaged with the cam convex portion 26 for continuously locking a second case body 12 with regard to a first case body 11 at a predetermined position, and; a cam engagement portion 32 on a rotation concave portion 3 to be engaged only with the first cam 23, and not with the second cam 24, allowing the first cam 23 to be rotated together with either one of the first case body 11 and second case body 12, when the second case body 12 is rotated with regard to the first case body 11.

A first cam 23 has e.g. a shape substantially the same as either one of a hinge case 22. In other words, the first cam 23 is formed with a cross section substantially of a rectangle, on which two of edges are curved toward both ends; further the first cam 23 is provided on a central portion thereof with a penetrating hole 23a through which a shaft 21 passes. The penetrating hole 23a has a diameter larger than a diameter of the shaft 21 and smaller than a flange portion 21a, and preferably e.g. slightly larger than the shaft 21. In addition the first cam 23 is equipped on a fore end surface (a surface opposed to the contact surface) with a shaft fitting portion 23b onto which a flange portion 21a of the shaft 21 is fitted; at assembly, either one of the fore end surfaces of the shaft 21 is located virtually in the same plane with either one of the fore end surfaces of the first cam 23.

On the contact surface of a first cam 23 (it may be called first can surface), two cam convex portions 26 are mounted at an interval of 180°. In other words, these two cam convex portions 26 are symmetrically mounted on the first cam surface. The shape of the cam convex portions 26 is not particularly limited, but is generally similar to a triangle protruding from the fore end surface, with a fore end portion thereof in the shape of a letter R. A cam surface between the cam convex portions 26 (cam surface except the latter) is desirably flat.

A second cam 24, similar to a first cam 23, has e.g. a shape substantially the same as a hinge case 22. In other words, the second cam 24 is formed with a cross section substantially of a rectangle, with curves on both side portions; further the second cam 24 is provided on a central portion thereof with a penetrating hole 24a through which a shaft 21 passes. The penetrating hole 24a has a diameter larger than a diameter of the shaft 21 and smaller than a flange portion 21a, and preferably e.g. slightly larger than the shaft 21. A second cam 24 is equipped on side portions with a rotation preventing portion 24b for preventing the second cam 24 from a rotation around an axis of the shaft 21; the second cam 24 can be shifted in an axial direction of the shaft 21, but cannot be rotated around it.

A second cam 24 is equipped on a contact surface thereof with four cam concave portions 27 of which two are to be engaged with cam convex portions 26: two of four cam concave portions 27 are located symmetrically at an interval of 180°, so as to be engaged with the cam convex portions 26, preferably e.g. at 0° and 180°; the remaining cam concave portions 27 are located symmetrically at an interval of 180° on the contact surface, so as to be engaged with the cam convex portions 26, preferably e.g. at 150° and 330°. Further it is favorable for a surface other than four cam concave portions 27 (it may be called a biasing surface) to be flat. Biasing means 25 are each set between the above-defined biasing surface and a bottom portion of each of the hinge cases 22.

A biasing means 25 is e.g. a compression coil spring 25a. Two compression coil springs 25a are e.g. provided; one end portion of each abuts on a biasing surface of a second cam 24, while other end portion on a bottom portion of a hinge case 22, thus pressingly biasing the second cam 24 toward a first cam 23. Accordingly friction forces working on the first cams 23 and on the second cams 24 each become increased, allowing a second case body 12 to be arrested at any position within a range of rotation with regard to a first case body 11.

The above described is alternatively expressed in the following manner: a condition in which a top surface of a first case body 11 is covered with a surface of a display portion 12a of a second case body 12, is defined as closed condition (it may be called also first closed condition); a rotation angle in this condition is 0°, where the first case body 11 and the second case body 12 are at a closed position; when the second case body 12 is relatively rotated to reach to 150° in the rotation angle, cam convex portions 26 intrude into two of cam concave portions 27 to be engaged therewith, and to be continuously locked thereto; this condition is defined half-opened condition, i.e. half-opened position of the first case body 11 and the second case body 12; when due to a further rotation from the half-opened position in an opening direction for reaching to 180° in the rotation angle, cam convex portions 26 intrude into another pair of cam concave portions 27 to be engaged therewith, and to be continuously locked thereto; this condition is defined fully opened condition, i.e. fully opened position of the first case body 11 and the second case body 12. In the meantime, the first case body 11 and the second case body 12 are each opened and closed via engagement convex portions 2 on the first case body 11 and rotation concave portions 3 and slide concave portions 4 on the second case body 12, an opening and closing is also accepted with a structure, in which engagement convex portions are mounted on the second case body, and rotation concave portions and slide concave portions 4 on the first case body.

Ball unit 70 is composed e.g. of a case member 71, a lid body 72, a ball bearing 73 as a slide convex portion, a receiving base member 74, compression coil springs 75; when either one of the ball units 70 is received in a ball unit housing portion 21c, only a portion of the former protrudes from a fore end surface of a shaft 21.

A case member 71 is formed in a shape substantially of a hollow cylinder. An interior of the case member 71 has a form of a circle, with diameter at each cross section gradually diminished from virtually central portion to an end portion (it may be called fore end portion). In other words, an aperture at the fore end portion of the case member 71 (it may be called appearance hole 71a) has a smaller diameter than that at other end portion (it may be called rear end portion). The case member 71 has a form of a ellipse, with at fore end portions thereof in a shape of a more oblong ellipse to form a flange portion 71b.

Ball bearing 73 is received inside a case member 71 which is described in the previous paragraph. The ball bearing 73 has a diameter larger, e.g. slightly larger than an appearance hole 71a, allowing a portion of the former to protrude from the latter, with the rest received inside.

An aperture at the rear end portion of a case member 71 as described in the previous paragraph, is closed via a lid body 72. The lid body 72, for closing the aperture at the rear end portion, is formed e.g. in the shape, substantially the same as the exterior form of the case member 71, of an ellipse. The lid body 72 is fixed, while covering all over the aperture at the rear end portion of the case member 71, e.g. via an ultrasonic welding to the case member 71. The ball bearings 73 each cannot entirely escape from the case member 71 due to the lid body 72 thus structured. The case member 71 and the lid body have each a shape and size so as to allow the fore end portion of the case members 71 to be located on the same plane as a fore end surface of a shaft 21, while the case members 71 to which the lid body 72 is fixed, are each fitted to a ball unit housing portion 21c and received inside.

A receiving base member 74 is received inside the case member 71, for supporting the ball bearing 73 which is to be movable. The receiving base member 74 has a shape substantially of a column. The receiving base member 74 is equipped on one end portion thereof with a hemisphere supporting portion 74a which supports the ball bearing 73 to be rotatable. Furthermore, the receiving base member 74 is equipped on another end portion thereof with a spring fitting portion 74b, around which one end portion of a compression coil spring 75 is fitted. Another end portion of the compression coil spring 75 abuts on an inner surface of a lid body 72, thus allowing a portion of a ball bearing 73 to protrude from an appearance hole 71a via the receiving base member 74, due to a biasing force of the compression coil spring 75, in case of no other force working on the ball bearing 73. In other words, when the ball unit 70 is received in a ball unit housing portion 21c on a fore end surface of a shaft 21, a portion of the ball bearing 73 protrudes from the fore end surface of the shaft 21.

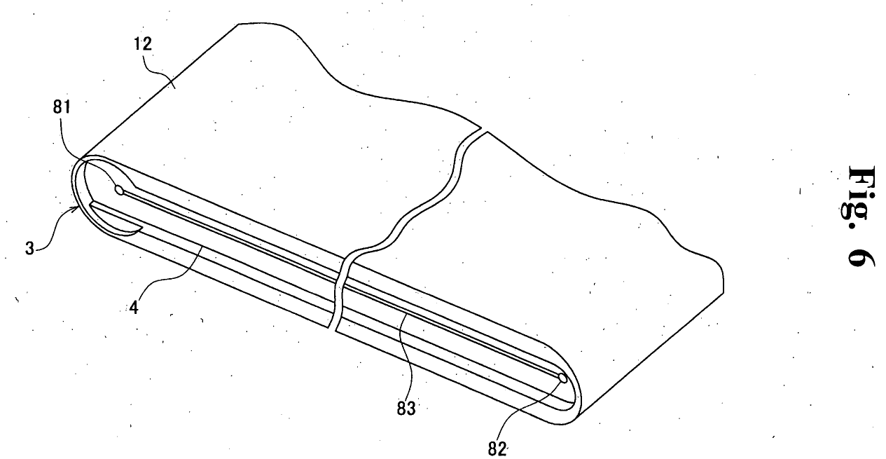

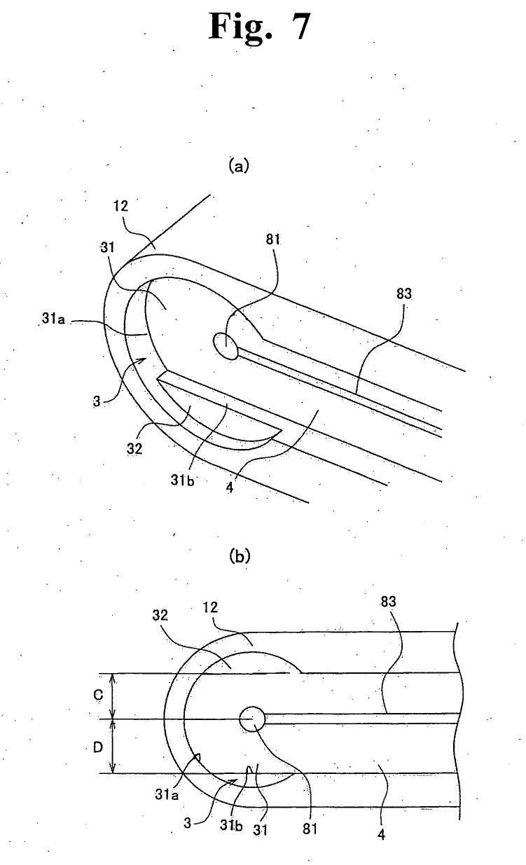

A rotation concave portions 3, as shown in FIGS. 6 and 7, supports a first case body 11 and a second case body 12 which are to be each rotatable, in an engagement with an engagement convex portion 2. The rotation concave portions 3 are provided on both side portions of the second case body 12, close to an end portion toward a speaker portion 12b. A first cam 23 and a second cam 24 of the engagement convex portion 2 which is a portion of an opening-closing unit 20 received in unit housing portions 14 on a side portion 13 of the first case body 11, and protruding from the side portions 13, is inserted into the rotation concave portions 3 and engaged therewith. The rotation concave portions 3 is double-decked, and composed of a first concave portion 31 into which the first cam 23 is inserted, and a second concave portion 32 (it may be called cam engagement portion 32) for an insertion of the second cam 24 therein.

First concave portion 31 have each a shape which allows for a fixing and insertion of a first cam 23 therein. In other words, the first concave portion 31 is composed of a curved portion 31a which may be in contact with one side portion of the first cam 23 or in vicinity thereto, and of linear cam portion 31b which is to be in contact with an upper portion and a lower portion of the first cam 23 or in vicinity thereto; when a second case body 12 is rotated with regard to a first case body 11, the first cam 23 is rotated along with the second case body 12, i.e. only the first cam 23 is rotated with regard to the shaft 21.

A second concave portion 32 has a shape which allows for a fixing and insertion of a second cam 24 therein, e.g. has a shape of a circle with a diameter slightly larger than that of curves on both side portions of the second cam 24, actually a shape of a circular arc; when a second case body 12 is rotated with regard to a first case body 11, the second cam 24 is rotated along with the first case body 11 and the shaft 21. This structure allows the first case body 11 and the second case body 12 to be each rotated in a range between 0° and 180°, since the first cam 23 and the second cam 24 of an opening-closing unit 20 received in a unit housing portion 14 of the first case body 11, are each inserted into the first concave portion 31 and the second concave portion 32 of rotation concave portions 3 and engaged therewith.

A slide concave portion 4 is engaged with a first cam 23 and a second cam 24 of an opening-closing unit 20 for supporting a first case body 11 and a second case body 12 to be slidable in a linear direction, without being rotatable however. The slide concave portion 4 is a guide groove which is joined with a rotation concave portion 3; each of them stretches in a longitudinal direction on both side portions and has a linear shape from a fore end portion to a rear end portion.

A slide concave portion 4 is connected to form one element with both of linear cam portions 31b; it has a shape substantially of the letter U on the cross section. Walls forming a groove of the slide concave portion 4 have preferably a distance slightly longer than a width between an upper surface and a lower surface either of a first cam 23 or of a second cam 24. It is desirable for the walls of the slide concave portion 4 to have each a height (i.e. a depth of the groove) enough to allow the first cam 23 and the second cam 24 superimposed on each other to be fixed inside the slide concave portion 4 and engaged therewith. Hence, due to an insertion of both of the above-indicated cams of an opening-closing unit 20 inside the slide concave portion 4, and to an engagement therewith, a first case body 11 and second case body 12 can each slide in a longitudinal direction thereof, i.e. a linear direction, between a closed condition and an opened condition.

A slide control mechanism 6 allows a first case body 11 and a second case body 12 to be each slid, while both case bodies are fully opened. In other words, the slide control mechanism 6 has preferably a structure, in which, when a display portion 12a is located on the top surface of the first case body 11, the top surface of the first case body 11 is exposed without being covered by the second case body 12 in a fully opened condition, i.e. at 180° in a rotation angle (see FIGS. 1B and 2), either one of closing operations, by a rotation or a slide operation of the first case body 11 and the second case body 12; it further prevents the above-identified case bodies from either one operation, when either other one is conducted, unless the case bodies are fully opened again. The slide control mechanism 6 is preferably composed of a first cam 23 on which a through hole 23a is cut on an eccentric position thereof, and a slide concave portion 4 which is joined with a rotation concave portion 3 on an eccentric position thereof.

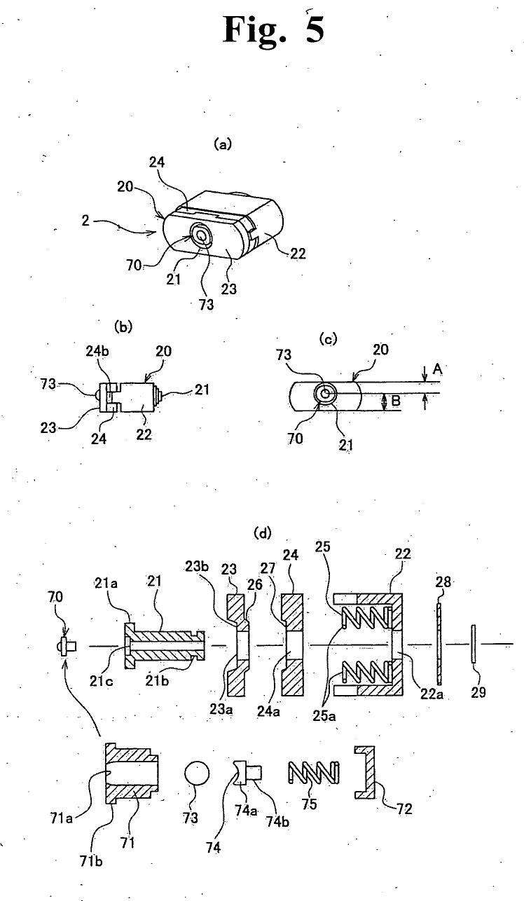

A through hole 23a of a first cam 23 is desirably attached either on an upper or a lower surface thereof, on an eccentric position. A first cam 23 is supported via a shaft 21 allowing for a rotation of the former with regard to the latter in eccentricity. Furthermore, it is preferable for an axis of the shafts 21 and ball bearings 73 to be each located in an eccentricity toward the first cam 23 (A<B, see FIG. 5C).

A rotation concave portion 3 is favorably set solely on a portion close to one end portion of a side portion of a second case body 12 (on an end portion toward a speaker portion 12b), i.e. on one end portion of slide concave portions 4. Further the slide concave portion 4 is preferably joined in eccentricity with the rotation concave portion 3. In other words, it is desirable for the slide concave portion 4 to be mounted in eccentricity toward either one of both side portions of the second case body 12, with regard to an axis of shaft 21 inside the rotation concave portions 3. The slide concave portion 4 is e.g. mounted in eccentricity toward a side with a display portion 12a (C<D, see FIG. 7B). Hence the slide concave portion 4 has a structure which enables a closing operation either via a rotation of the first case body 11 and the second case body 12, or via a slide operation of the both; further according to the above-mentioned structure, the both case bodies are slid to obtain a closed condition, i.e. a slide position in which they are superimposed on each other (this condition may be called a second closed condition).

Further a rotation concave portion 3 is favorably equipped with a first bearing engagement portion 81 in the shape of a spherical surface to be engaged with a ball bearing 73 which protrudes from a fore end surface of a shaft 21. In the meantime, slide concave portions 4 are each favorably equipped with a second bearing engagement portion 82 in the shape of a spherical surface to be engaged with a ball bearing 73, for retaining one of the closed conditions of the first case body 11 and the second case body 12, in which the top surface of the first case body 11 is covered by the second case body 12.

Moreover, it is also accepted that each of slide concave portions 4 includes a slide groove portion 83, on which a ball bearing 73 is slid. Preferably the slide groove portion 83 is less deep than bearing engagement portions 81 and 82, and has e.g. a cross section in a shape of a circle. The slide groove portion 83 is e.g. formed on a straight line opposed to a ball bearing 73, when a first bearing engagement portion 81 and a second bearing engagement portion 82 are contacted with each other and an opening-closing unit 20 is slid along the slide concave portion 4.

In the following the function of an opening-closing mechanism 1 and a portable telephone 10 according to the present invention will be described.

An ordinary condition in which a portable phone 10 is out of use is a first closed condition, where a first case body 11 and a second case body 12 are superimposed on each other. The first closed condition is further described by a condition in which at 0° in a rotation angle, a key board portion 11a, etc. of the first case body 11 is covered by the second case body 12 having a surface with a display portion 12a downward. In this condition, a first cam 23 and a second cam 24 of an opening-closing unit 20 are inserted into a rotation concave portion 3 and engaged therewith, and at 0° in a rotation angle, a cam convex portion 26 is engaged with a cam concave portion 27 and continuously locked therewith at the position. Furthermore, the second cam 24 is inserted into a second concave portion of the rotation concave portion 3, due to a position of the second cam 24 out of alignment with the slide concave portion 4, an opening-closing unit 20 is not engaged with the slide concave portion 4. In other words, the first case body 11 and the second case body 12 are not slid with regard to each other.

For use of a portable telephone 10 as described in the previous paragraph, a first case body 11 is held on user's left hand and a second case body 12 on his right hand, and thus the second case body 12 is rotated (opened) around an axis of a shaft 21 in a direction in which a second case body 12 separate from a first case body 11. Hence cam convex portions 26 escape from cam concave portions 27 (the cam convex portions 26 are disengaged from the cam concave portions 27), and at 150° in a rotation angle, the cam convex portions 26 intrude into the cam concave portions 27, and are engaged and locked therewith at the position. This condition is a half opened condition. In other words, the second case body 12 is opened, allowing for a call. Accordingly functions for a call and others are available in this condition. Furthermore, when the second case body 12 is additionally rotated to reach to 180° in a rotation angle, as shown in FIGS. 1B and 2, the cam convex portions 26 intrude into the cam concave portions 27 to be engaged with the cam concave portions 27 and locked at the position, presenting a fully opened condition. Also in this condition a use for a call and others is possible.

For a reversion to a first closed condition after a call and others, a first case body 11 is held on user's left hand and a second case body 12 on his right hand, the second case body 12 is rotated in a direction contrary to the one indicated in the preceding paragraph (i.e. a direction in which the second case body 12 approaches to the first case body 11). Hence cam convex portions 26 are disengaged from cam concave portions 27, and at 0° in a rotation angle, the cam convex portions 26 intrude into the cam concave portions 27, and are locked therewith at the position, thus a first closed condition is restored, with both case bodies being superimposed on each other.

Furthermore, a portable telephone 10 according to the present invention is available in a half opened condition and fully opened condition, and further in a second closed condition, for viewing moving images displayed on a display portion 12a, such as LCD via functions using communication lines, etc., apart from a use for call. Furthermore, in the fully opened condition, i.e. at 180° in a rotation angle, due to a rotation of a second case body 12 with regard to a first case body 11 in a range of 180°, second cam 24 is found in the same position (also substantially the same position) with slide portions 4; accordingly, in this fully opened position, both of closing operations are possible, one via rotation of the second case body 12 with regard to the first case body 11, and other via a sliding operation of the second case body 12 on the first case body 11. The second case body 12 is superimposed on the first case body 11 after a sliding operation for one of the closed conditions, since ball bearings 73 are each engaged with a first bearing engagement portion 81; this fully opened closed condition is retained without sliding of the case bodies.

Thus e.g. a second case body 12 on user's left hand is slid with regard to a first case body 11 on his right hand from a fore end portion of the first case body 11 to a rear end portion thereof. Then, ball bearings 73 each escape from a first bearing engagement portion 81 (the ball bearings 73 are each disengaged from the first bearing engagement portion 81) and are each slid along a slide groove portion 83. Afterward when a first cam 23 and a second cam 24 of an opening-closing unit 20 are each contacted with an end portion of slide concave portion 4, as shown in FIG. 1C, the ball bearing 73 is engaged with the second bearing engagement portion 82, the first case body 11 and the second case body 12 are retained in a second closed condition. In this second closed condition the second case body 12, with a display portion 12a facing upward, is superimposed on the first case body 11. Accordingly, the second case body 12 does not disturb a viewing of images displayed on the display portion 12a, which results in an improved operability.

To open a portable telephone 10 in a second closed condition, e.g. a second case body 12 on user's left hand is slid with regard to a first case body 11 on his right hand from a rear end portion to a fore end portion thereof. Accordingly a ball bearing 73 escapes from a second bearing engagement portion 82 (the ball bearing 73 is disengaged from the a second bearing engagement portion 82), slid on a slide groove portion 83; afterward a first cam 23 and a second cam 24 of an opening-closing unit 20 are each contacted with an end portion of a slide concave portion 4, and the ball bearing 73 is engaged with a first bearing engagement portion 81. Accordingly the first case body 11 and the second case body 12 are retained in a fully opened condition (see FIGS. 1B and 2).

Therefore, in an opening-closing mechanism 1 and a portable telephone 10 according to the present invention, a first case body 11 and a second case body 12 can be opened and closed with a supporting point on one end portion, for achieving a closed position, a half opened position and a fully opened position. In addition, at a fully opened position, the second case body 12 is slid on the first case body 11 to achieve a second closed position, or a slide position, in which the first case body 11 is superimposed on the second case body 12. Accordingly two types of opening and closing operations are possible, one via an ordinary rotation and the other via slide operation, which leads to an improved operability.

Further in opening or closing a first case body 11 and a second case body 12 via rotation, fore end surfaces of a cam convex portion 26 escape from cam concave portions 27. Thereupon, end portions of cam convex portions 26 are sliding on the plane contact surface other than the cam concave portions 27 of second cams; when a rotation of the second case body 12 is arrested at this point, friction forces are generated due to a contact of fore end surfaces of cam convex portions 26 with the plane contact surfaces, arresting the second case body 12 at this point. In other words, if the rotation angle at this point is a free stop angle, the second case body is arrested at the angle.

Moreover, in opening and closing a first case body 11 and a second case body 12 via a sliding operation, if the sliding operation is arrested in the mid-course of the operation with regard to the first case body 11, the second case body 12 stops at the position. In other words, when the second case body 12 is slid with regard to the first case body 11, a ball bearing 73, while sliding along a slide groove portion 83 inside a slide concave portion 4, is pressed toward the slide groove portion 83 via a biasing force of the compression coil spring 75. Accordingly when a slide operation of the second case body 12 is arrested, due to friction forces produced by the contact of the slide groove portion 83 with the ball bearing 73, the second case body 12 is arrested at the position. Therefore, the second case body 12 is arrested at the desired position.

As explained above, in a portable equipment according to the present invention, a first case body and a second case body can be opened and closed with a supporting point on one end portion, allowing for a closed condition, a half opened condition and a fully opened condition. Furthermore, since the portable equipment allows for a slide position, or a closed condition in which a first case body and a second case body are slid to be superimposed, two kind of opening and closing operations, one via an ordinary rotation and the other via a sliding operation, are both available, which leads to an improved operability. Therefore, the portable equipment is suitable especially for use in a portable telephone among the portable equipment.

What is claimed is:

1. A portable equipment for allowing, via opening-closing mechanisms, for a closed condition, in which a top surface of either one of a first case body and a second case body is covered by either other one, and for an opened condition, in which either one of said first case body and said second case body is exposed:
wherein at least one of said opening-closing mechanisms is composed of an engagement convex portion attached to either one of said first case body and said second case body, a rotation concave portion which, located on either other one of said first case body and said second case body, rotatably supports said first case body and said second case body; a slide concave portion which is joined with said rotation concave portion, and supports said first case body and said second case body to be each slid by an engagement with said engagement convex portion, a rotation cam mechanism which restricts a rotation of said first case body and said second case body, and a slide control mechanism which allows said first case body and said second case body to be slid, while both case bodies are fully opened;
wherein said portable equipment allows, via said opening-closing mechanism, said second case body to be opened and closed with regard to said first case body, with a supporting point at one end portion thereof, thus enabling said second case body to be fixed at closed, half opened and fully opened positions; and
wherein said first case body and said second case body are each slid from said fully opened position to be superimposed on each other at a slide position.

2. A portable equipment according to the claim 1:
wherein said engagement convex portion has a shaft and a cam provided on an outer circumference around an axis thereof;
wherein said slide control mechanism is composed of said cam including a through hole penetrating said shaft in eccentricity, said slide concave portion joined in eccentricity with said rotation concave portion to constitute altogether one element.

3. A portable equipment according to the claim 2:
wherein a ball unit is mounted on a fore end portion of said shaft with a slide convex portion, said ball unit can appear from the fore end portion and is biased in a direction in which said slide convex portion protrudes, and;
wherein said slide concave portion is provided with a slide groove portion that slides said slide convex portion.

4. A portable equipment according to the claim 3:
wherein said ball unit is composed of a case member attached to said shaft and having an appearance hole, a ball bearing installed in said case member so as to appear from said appearance hole, and a biasing member for biasing said ball bearing in a direction in which said ball bearing protrudes.

5. A portable equipment according to claim 1:
wherein said engagement portion has a shaft;
wherein said rotation cam mechanism is composed of a first cam mounted on an outer circumference of a fore end portion of said shaft to be rotatable around said shaft, a second cam to be shifted in an axial direction of said shaft and contacted on a surface with said first cam, a biasing means for biasing the second cam toward said first cam, cam convex portions mounted on either one of contact surfaces of said first cam and of said second cam, cam convex portions formed on a contact surface of said first cam and/or a contact surface of said second cam for being engaged with the cam convex portions and locking said first case body and said second case body at a selected position, and cam rotation portions mounted on rotation convex portions for rotating only said first cams with regard to said shaft, in parallel to a relative rotation of said first case body and said second case body.

6. A portable equipment according to claim 1:
wherein a hinge case is fixed to either one of said first case body and said second case body; a shaft mounted on the hinge cases; a second cam mounted for restraining a rotation of said shaft via an engagement with said hinge case; a first cam mounted on an outer periphery of a fore end portion of said shaft; and a biasing means mounted between said second cam and said hinge case.

7. A portable equipment according to claim 1:
wherein either one of said first case body and said second case body is formed in a shape of U, with upright portions on both side portions;
wherein an opening-closing unit is fixed on a portion on an inner surface close to an end portion, on the side portion;
wherein a slide concave portion is mounted on a side portion of either other one of said first case body and said second case body, and;
wherein said rotation concave portion is mounted on one end portion of the slide concave portion.
